(19) United States
(12) Patent Application Publication
(10) Pub. No.: US 2006/0176294 A1
(43) Pub. Date: Aug. 10, 2006

(54) Cursor for electronic devices

(76) Inventor: Johannes Vaananen, Oulu (FI)

Correspondence Address: COHEN, PONTANI, LIEBERMAN & PAVANE, 551 FIFTH AVENUE, SUITE 1210, NEW YORK, NY, 10176, US

(21) Appl. No.: 10/530,004

(22) PCT Filed: Oct. 7, 2002
(86) PCT No.: PCT/FI02/00785

§ 371 Date: Feb. 14, 2006

(51) Int. Cl. G06T 15/00

(52) U.S. Cl. 345/419

(57) ABSTRACT

The present invention describes a method, electronic device and computer program for displaying a cursor on the display of an electronic device. The size of the display is typically so small that only part of a virtual view is displayed at one time on the display. The user of the electronic device changes the displayed part of the virtual view on the display. In the present invention, a correlation between the cursor location on the display and the location of the displayed part of the virtual view within the whole virtual view is determined so that the cursor location on the display reflects the location of the displayed part of the virtual view in proportion to the whole virtual view. In other words, the user can quickly perceive the exact location e.g. on the virtual desktop or in large digital material displayed on the display of an electronic device.

### FIELD OF THE INVENTION

The present invention relates to electronic devices. In particular, the present invention relates to a novel and improved method for computer programs and electronic devices to know the current location in a virtual view that is larger than the physical display.

### BACKGROUND OF THE INVENTION

The size of the display of an electronic device sets certain limits for presenting information on the display. A small display is not the best place to present a large amount of information. If the amount of information is large and all the information is presented on the display at the same time, detail may become illegible. One solution to this problem is a so-called ‘virtual desktop’. There the total amount of the digital information is represented in a greater space than the actual amount of information presented on the display of the device at one time. Therefore, means for accessing the information represented outside the viewable area are needed. This is achieved, e.g. with scroll bars located on the display.

The following notions are used in this application:

“Cursor” is taken to mean any pointer that will have a relative variable position in data. The cursor may be an item that signifies where a mouse or other navigation tool is pointed to, or to where text will be inserted in the data under study when written, or the like.

“Virtual view” is taken to mean the entire spatially arranged data set in which the user may navigate at a given time.

“Displayed part of virtual view” is taken to mean the part of the aforementioned virtual view that is or may be displayed on the display of the electronic device with access to the said virtual view.

When the information to be presented on the display is considerably larger than the display area, the current location within the information is not well perceived. For example, an electronic device, e.g. a Portable Digital Assistant (PDA), offers a map application. The map comprises an area of which only 1/10000 at a time can be presented in readable form on the display of the electronic device in such a detailed view, the whole map is represented logically for the processor of the electronic device as a 100×100 two-dimensional matrix. The user of the electronic device can ‘move’ within the map, e.g. with scroll bars or by some other methods or means. However, the user is not provided with the information what the current location within the whole map is.

Some solutions exist that may be regarded as prior-art solutions. One solution e.g. within a map is to provide the user with coordinate readings. Yet another solution is to show the coordinate reading of the cursor on the display. Yet another solution is to show the grids on the display. The aforementioned solutions are typically available in computers, but some may also be available in mobile devices, such as PDA's, mobile phones, remote controls, or like devices.

The aforementioned solutions have, however, several weaknesses. Coordinate readings have certain maximum values that the user of the device should be aware of. The coordinates may give the exact location within the digital information. However, the knowledge of coordinates is practically useless because the overall size of the digital material is unclear and the coordinates do not provide an intuitive picture of current location within the digital material. In other words, when coordinates are used, the user is not aware of his/her relative position on the whole digital material. Instead, the coordinates express only certain relative measuring scale of the digital information. And above all, coordinates do not promote quick navigation.

Another solution may be that a small distinct area is provided within the display. The distinct area shows the current location of the user in the whole digital material. The problem with this solution is that when using e.g. an electronic device, there is not enough space to be separated for the distinct area mentioned above. Even if the distinct area showing the current location of the user in the whole digital material were provided, the size of it would be so small that it could not be used efficiently.

The present invention considerably alleviates the above-identified problems. Particularly, with the present invention it is possible for the user to quickly perceive the exact location e.g. on a ‘virtual desktop’ or in large digital information represented with a display of an electronic device.

### BRIEF SUMMARY OF THE INVENTION

The present invention describes a method, electronic device and computer program for displaying a cursor on the display of an electronic device. The size of the display is so small that only part of a virtual view is displayed at a time on the display. The user of the electronic device changes the displayed part of the virtual view on the display. In the present invention, a correlation between the cursor location on the display and the location of the displayed part of the virtual view within the whole virtual view is determined so that the cursor location on the display reflects the location of the displayed part of the virtual view in proportion to the whole virtual view. In other words, the user can quickly perceive the exact location e.g. on the virtual desktop or in large digital information displayed on the display of the electronic device.

In a preferred embodiment, changing the orientation of the electronic device changes the view on the display. In other embodiments, the view is changed by using scroll bars, a mouse etc.

In one embodiment, the correlation between cursor position and the displayed part of the virtual view is linear. In another embodiment, this correlation is non-linear.

The present invention enables also a very quick way to move to a desired area within large digital material that must be viewed in parts on the display of the electronic device. The user moves the cursor to a desired location on the display. Because a certain location of the cursor on the display has been bound to a certain view of the whole digital material, quick movements can be achieved.

In a preferred embodiment, the electronic device is a mobile phone or a Personal Digital Assistant (PDA), remote control, web tablet, digital camera or electronic device equipped with a pointing device etc.

The present invention has several advantages over the prior-art solutions. With the present invention it is possible for the user to quickly perceive the exact location of the displayed part on the virtual desktop or in large digital material. Furthermore, the user can determine his/her location on the larger virtual view by looking at the position of the cursor. The user can also move the cursor to the corner of the larger virtual view without having to scroll the larger virtual view corner into centre of the physical display.

### BRIEF DESCRIPTION OF THE DRAWINGS

In the drawings:

FIG. 1 is a flow diagram illustrating the method of assigning cursor location and displayed part location within a larger virtual view by moving a cursor in accordance with the present invention.

FIG. 2 is a flow diagram illustrating the method of assigning cursor location and displayed part location within a larger virtual view by moving the displayed part in accordance with the present invention.

FIG. 3 is a flow diagram illustrating an embodiment of the method of assigning cursor location and displayed part location within a larger virtual view in accordance with the present invention.

FIG. 4 is a block diagram illustrating an electronic device in accordance with the present invention, and

FIG. 5 is a block diagram illustrating the location of the cursor in accordance with the present invention.

Some embodiments of the invention are depicted in the dependent claims.

### DETAILED DESCRIPTION OF THE INVENTION

Reference will now be made in detail to the embodiments of the present invention, examples of which are illustrated in the accompanying drawings.

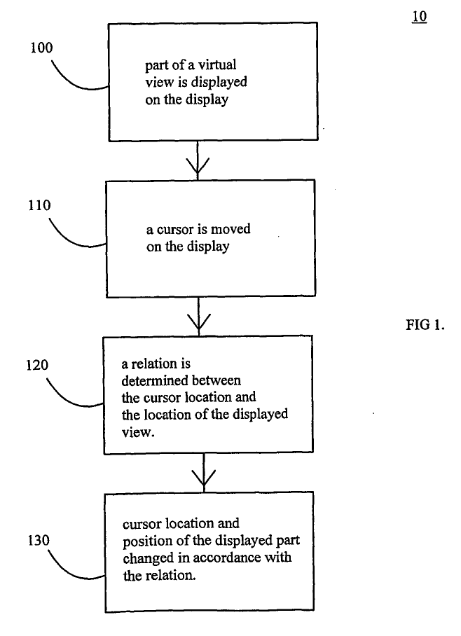

Referring to FIG. 1 and phase 100 a part of the entire virtual view is displayed on the display. This displayed part may be of any proportion or scale to the entire virtual view. In phase 110 the cursor is moved on the display. The cursor maybe moved by a mouse, selection of keys, touch pad, joystick or any other device suitable for moving a cursor. In phase 120 a relation is determined between the cursor location and the location of the displayed view.

In some embodiments the relation is linear in other embodiments progressive with deviation from origin or the like. In some embodiments the cursor, the virtual view, and/or the displayed part have the same origin. In phase 130 the cursor location and the position of the displayed part are changed in accordance with the said relation.

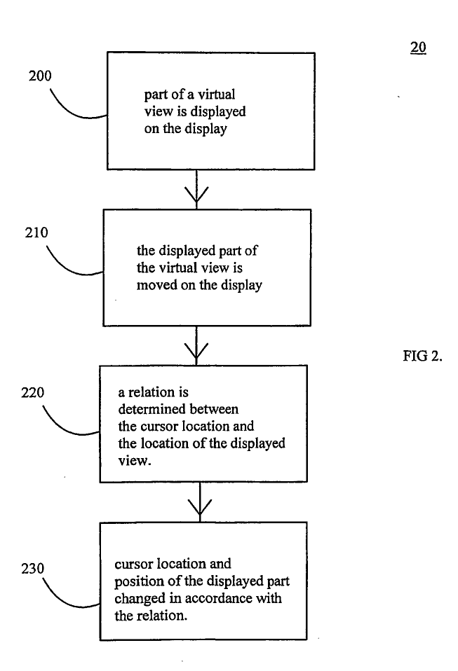

Referring to FIG. 2 and phase 200 a part of the entire virtual view is displayed on the display. In phase 210 the displayed part of the virtual view is moved on the display. The displayed part of the virtual view maybe moved by a mouse, selection of keys, touch pad, joystick or any other device suitable for moving a cursor. In phase 220 a relation is determined between the cursor location and the location of the displayed view.

In phase 230 the cursor location and the position of the displayed part are changed in accordance with the said relation in response to user actions.

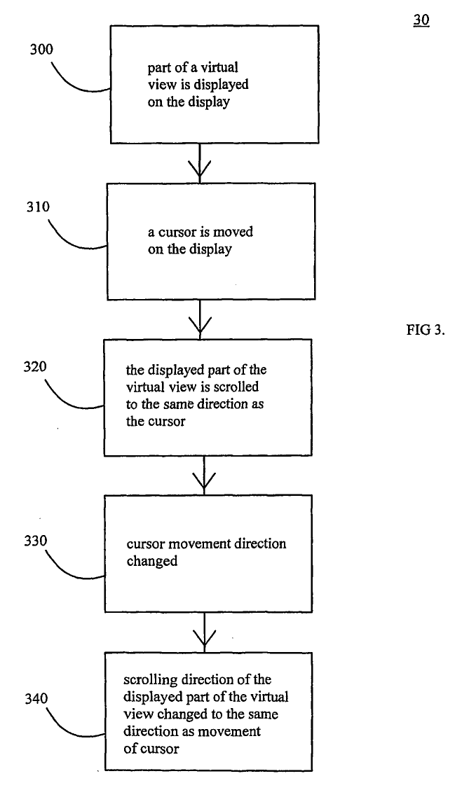

Referring to FIG. 3 and phase 300 a part of the entire virtual view is displayed on the display. This displayed part may be of any proportion or scale to the entire virtual view. In phase 310 the cursor is moved on the display. In phase 320, in response to moving the cursor the displayed part of the virtual view is scrolled to the same direction as the cursor, with same or differing speeds. In phase 330 the cursor movement direction is changed, for example in response to a user action. As a response to this the scrolling direction of the displayed part of the virtual view is changed to the same direction as the movement of the cursor. The speeds may be the same or different.

It is clear that the user may control either the movement of the cursor or the displayed part and thereby further control the movement of the other in accordance with the invention. Likewise it is clear that the phases 100, 110, 120, 130, 200, 210, 220, 230, 300, 310, 320, 330 and/or 340 may take any permutations, and thus be executed in a different order.

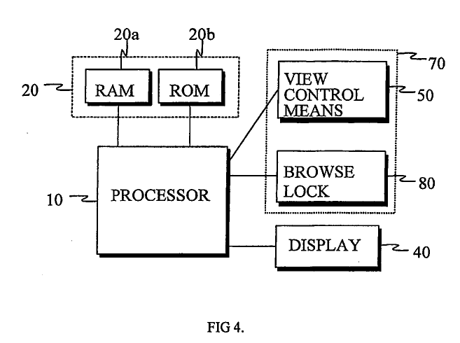

Referring to FIG. 4 the memory 20 of the electronic device is used to compute and store all the needed data for and related to characters, pictures, lines, links, video or pixels that can be conveniently displayed on the display device at a time. Usually, only a portion of the virtual view can be displayed on the display 40 at a time. Therefore, view control means 50 are provided. View control means 50 refer preferably to motion control means, e.g. various motion sensors but can also be prior-art systems like other pointing devices used to determine relative movement and/or orientation.

Different kinds of sensors exist for determining location and orientation of the electronic device, e.g. acceleration sensors, gyroscopes and video image for analysing location. For example, with the view control means 50 it is possible to measure tilting movements of the electronic device. The processor 10 receives the measurement results and interprets them. The motion sensors can be e.g. piezo-electric or capacitive producing an analog voltage, which is proportional to the acceleration factor. With the motion sensors it is possible to measure one, two or three-dimensional accelerations. The measurement of tilting movements is based on the fact that the highest acceleration is parallel to the gravity of the earth. Therefore, the orientation of the electronic device can be defined in relation to the earth. It is also possible to use gyroscopes with its various forms to measure the orientation of the electronic device. The quantities measured are e.g. tilting angle and accelerations.

In a preferred embodiment, the view on the display 40 is moved to the same direction as the electronic device is tilted. Moreover, a certain orientation of the electronic device may display the same view of the whole virtual view on the display 40. Therefore, managing the view changes is very easy and logical. The view control means 50 may also refer to scroll bars or to the use of a mouse.

The electronic device may also comprise a display adapter coupled to the display 40 and to the processor 10. The display adapter with the processor 10 controls the display 40. In order not to use the data memory 20a for storing display-related information, the display adapter may comprise a data buffer in which the information to be displayed on the display 40 is stored.

The electronic device may also comprise a browse lock 80 with which it is signalled when the browsing is executed. In a preferred embodiment, the browse lock refers to a push button. Together with the view control means 50 the browse lock forms means for moving 70 the cursor or the displayed part to a desired location. In other words, when the browse lock is off, the user of the electronic device can move the cursor to a desired location on the display with the displayed part being static.

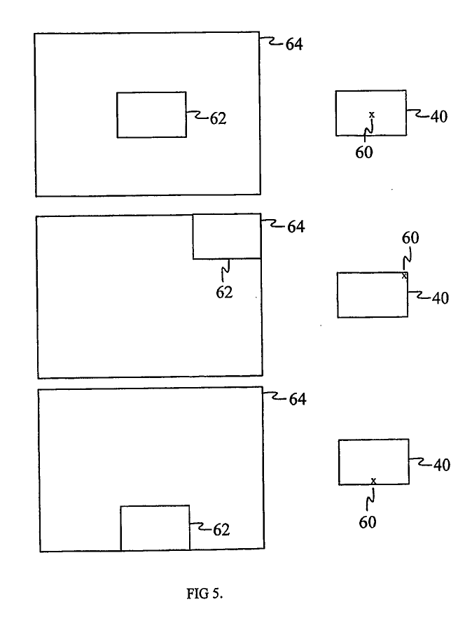

FIG. 5 illustrates the location of the cursor 60 on the display 40 of the electronic device. The cursor's 60 actual location on the physical display 10 is relatively the same or follows the same tendency as the physical display 40 centre point is related to the larger virtual view 64 while scrolling. In other words, a correlation between the cursor 60 location on the display 40 and the location of the displayed part 62 of the virtual view 64 within the whole virtual view is determined so that the cursor 60 location on the display 40 reflects the location of the displayed part 62 of the virtual view in proportion to the whole virtual view 64. The same user method that controls the scrolling, may control the cursor 60 at the same time as well. In FIG. 5, the mark ‘x’ represents the cursor 60. However, other forms of cursors can naturally be used and the appearance of the cursor 60 may be highly variable in accordance with the invention.

The present invention describes a solution to the question of how to combine scrolling operation (might be done e.g. by scroll ball, motion control, mouse etc.) with cursor 60 movements when scrolling a virtual view 64 larger than physical display 10, at the same time, the usage being intuitive.

When the user scrolls the larger virtual view 64 right (so that image on the display 40 moves to the left), the cursor 60 on the display 40 moves to the right. In many embodiments, the cursor 60 always moves to the same direction on the display 40 to which the user scrolls the larger virtual view 64. The relationship between these movements can be linear or non-linear. In the following, the linear case is described.

In the example the coordinate system is two-dimensional. The following parameters are defined:

Larger view centre point=(0,0)

Larger view upper left corner=(−vxmax, −vymax)

Larger view lower right corner=(vxmax, vymax)

Physical display centre point=(0,0)

Physical display upper left corner=(−pxmax,−pymax)

Physical display lower right corner=(−pxmax,−pymax)

Physical display centre point location on larger view=(vx,vy)

Cursor location on physical display=(x,y)

In the physical display 40, one step in the larger virtual view coordinate system equals to one step in the physical display 40 coordinate system. For simplicity 1:1 zoom factor and linear algorithm are used in the following formulas.
x=pxmax*(vx/(vxmax−pxmax))
y=pymax*(vy/(vymax−pymax))

Cursor location on the larger virtual view is

CursorX=vx+x

CursorY=vy+y

As it can be seen in FIG. 5, the cursor 60 implies intuitively and logically the part that is seen at a certain moment on the display 40. View 62 refers to the viewed part of the larger virtual view 64 that is displayed on the display 40 at a time.

The advantage of this invention is that the user can determine his/her location on the larger virtual view by looking at position of the cursor. Furthermore, the user can move the cursor to the corner of the larger virtual view without having to pan larger view corner into centre of the physical display.

It is obvious to a person skilled in the art that with the advancement of technology, the basic idea of the invention may be implemented in various ways. The invention and its embodiments are thus not limited to the examples described above, instead they may vary within the scope of the following claims.

1. A method for displaying a cursor on a display of an electronic device, wherein only part of a virtual view is displayed at a time on the display of the device, wherein the method comprises the steps of:
changing the displayed part of the virtual view on the display in response to user actions;
displaying a cursor on the display,
characterized in that the method further comprises the step of:
determining a relation between the cursor location on the display and the location of the displayed part of the virtual view within the whole virtual view so that the cursor location on the display reflects the location of the displayed part of the virtual view in proportion to the whole virtual view.

2. The method according to claim 1, characterized in that the cursor is moved to the same direction as the virtual view is scrolled.

3. The method according to claim 1, characterized in that the relation is linear or non-linear.

4. The method according to claim 1, characterized in that the method further comprises the steps of:
moving the cursor to a desired location; and
displaying the corresponding part of the virtual view on the display.

5. The method according to claim 1, characterized in that changing the orientation of the electronic device changes the view on the display.

6. The method according to claim 1, characterized in that the cursor, the displayed part of the virtual view and/or the virtual view have the same origin.

7. The method according to claim 1, characterized in that the deviation of the cursor from the centre of the displayed part of the virtual view is proportional to the deviation of the displayed part from the origin of the virtual view.

8. An electronic device for displaying a cursor on a display of the electronic device, the electronic device comprising at least:
a processor (10);
a memory (20) coupled to the processor (10), the memory (20) comprising a virtual view suitable for conveying information to the user of the electronic device;
a display (40) coupled to the processor (10);
view control means (50) with which the view on the display (10) is changed;
a cursor (60) on the display (10),
characterized in that the electronic device further comprises:
a relation between the cursor (60) location on the display (40) and the location of the displayed part of the virtual view within the whole virtual view so that the cursor (60) location on the display reflects the location of the displayed part of the virtual view in proportion to the whole virtual view.

9. The electronic device according to claim 8, characterized in that view control means (50) refer to motion control means, scroll bar(s) or a mouse.

10. The electronic device according to claim 8, characterized in that the electronic device comprises:
means for moving (70) the cursor (60) to a desired location and in response to the movement, displaying the corresponding part of the virtual view on the display (40).

11. The electronic device according to claim 8, characterized in that the electronic device is a mobile phone.

12. The electronic device according to claim 8, characterized in that the electronic device is a Personal Digital Assistant (PDA), remote control, gaming console, web tablet, wireless device, mobile camera or internet appliance.

13. The electronic device according to claim 8, characterized in that the cursor, the displayed part of the virtual view and/or the virtual view are arranged to have the same origin.

14. The electronic device according to claim 8, characterized in that the deviation of the cursor from the centre of the displayed part of the virtual view is arranged to be proportional to the deviation of the displayed part from the origin of the virtual view.

15. A computer program embodied on a computer-readable medium, wherein the computer program executes the program steps recorded in a computer-readable medium to perform a method for displaying a cursor on a display of an electronic device, wherein only part of a virtual view is displayed at a time on the display of the electronic device, wherein the method comprises the steps of:
changing the displayed part of the virtual view on the display in response to user actions;
displaying a cursor on the display;
characterized in that the method further comprises the step of:
determining a relation between the cursor location on the display and the location of the displayed part of the virtual view within the whole virtual view so that the cursor location on the display reflects the location of the displayed part of the virtual view in proportion to the whole virtual view.

16. The computer program according to claim 15, characterized in that the cursor is moved to the same direction as the virtual view is scrolled.

17. The computer program according to claim 15, characterized in that the relation is linear or non-linear.

18. The computer program according to claim 15, characterized in that the method further comprises the steps of:
moving the cursor to a desired location; and
displaying the corresponding part of the virtual view on the display.

19. The computer program according to claim 15, characterized in that changing the orientation of the electronic device changes the view on the display.

20. The computer program according to claim 15, characterized in that the cursor, the displayed part of the virtual view and/or the virtual view are arranged to have the same origin.

21. The computer program according to claim 15, characterized in that the deviation of the cursor from the centre of the displayed part of the virtual view is arranged to be proportional to the deviation of the displayed part from the origin of the virtual view.
